(19) United States
(12) Patent Application Publication
(10) Pub. No.: US 2024/0240440 A1
(43) Pub. Date: Jul. 18, 2024

(54) MAGNETIC ATTRACTION FIXING STRUCTURE FOR SHOWER HEAD

(71) Applicants: Shifa HUANG, Fujian (CN); Baosen HONG, Fujian (CN); Longyun SHI, Fujian (CN); Guozhong WU, Fujian (CN)

(72) Inventors: Shifa HUANG, Fujian (CN); Baosen HONG, Fujian (CN); Longyun SHI, Fujian (CN); Guozhong WU, Fujian (CN)

(21) Appl. No.: 18/144,862

(22) Filed: May 9, 2023

(30) Foreign Application Priority Data
Jan. 17, 2023 (CN) 202310071016.0

(51) Int. Cl. E03C 1/02; B05B 15/62; E03C 1/04

(52) U.S. Cl. CPC E03C 1/021; B05B 15/62; E03C 1/0408; E03C 2201/40

(57) ABSTRACT

A shower head magnetic attraction fixing structure, including a shower component with a shower body and a first magnetic attraction mechanism retractably provided on a back surface of the shower body, and a fixing component; the first magnetic attraction mechanism flushes with the back surface of the shower body when there is no magnetic attraction; the fixing component has a fixing seat having a fixing groove to embed the first magnetic attraction mechanism, and a second magnetic attraction mechanism inside an upper wall of the fixing groove; connecting buckles are provided to be biased to eject out of the inner side walls of the fixing groove and capable of retracting into the inner side walls; the connecting buckles are locked into a limiting ring groove of the first magnetic attraction mechanism to fix the first magnetic attraction mechanism and the second magnetic attraction mechanism.

### BACKGROUND OF THE INVENTION

The present invention relates to the technical field of shower head fixing devices, and in particular to a magnetic attraction fixing structure for a shower head.

A shower head is a water outlet device commonly used in a bathroom, and has various water outlet modes according to different products, so as to meet different requirements of users. It is expected that the shower head can be fixed onto the wall when the shower head is not used, so various fixing devices for shower heads have been developed. Among them, shower head socket holders are commonly seen, the shower head socket holders are generally locked onto the wall through screws, and a C-shaped holder for hanging the shower head is formed on the shower head socket holder.

Later, in order to use the shower head more conveniently and rapidly, a magnetic attraction fixing structure for a shower head is further designed. Through the arrangement of devices such as magnets on a back surface of the shower head and corresponding magnets on a fixing seat, the shower head can be directly attracted by magnetic force and attached onto a surface of the fixing seat when the shower head is placed close to the fixing seat. The magnetic attraction fixing mode has an extremely high requirement for the placing position of the shower head, and specifically, matching surfaces between the shower head and the fixing seat should correspond face-to-face such that the magnetic force is sufficient enough to fix the shower head and prevent the shower head from falling off. In this case, once a user accidentally touches the shower head or the water pipe connected to the shower head, the matching surfaces between the shower head and the fixing seat may be misplaced, and so the magnetic force is reduced, and thus the shower head falls off and may be possibly broken; moreover, in a prior art magnetic attraction fixing mode, a protruding structure is arranged on the surface of the shower head to mount a magnet, and so the shower head has an uneven surface and is easily bumped and impacted during use, thereby probably damaging the magnetic attraction structure or scratching the user.

### BRIEF SUMMARY OF THE INVENTION

The present invention aims to provide a magnetic attraction fixing structure for a shower head, in order to improve stability of the magnetic attraction fixing structure and to prevent the shower head from falling off due to unintended touch.

In order to achieve the above objective, the solution of the present invention is as follows:

After the above technical solution is adopted, the present invention has the following technical effects:

A magnetic attraction fixing structure for a shower head, comprising a shower component and a fixing component, wherein the shower component comprises a shower body and a first magnetic attraction mechanism; the first magnetic attraction mechanism is provided on a back surface of the shower body and is perpendicularly movable away from the back surface of the shower body; a circumferential surface of the first magnetic attraction mechanism is provided with a limiting ring groove; an end surface of the first magnetic attraction mechanism flushes with the back surface of the shower body when the first magnetic attraction mechanism is not being moved; the fixing component comprises a fixing seat and a second magnetic attraction mechanism; the fixing seat is provided with a fixing groove in which the first magnetic attraction mechanism is embedded when being magnetically attracted by the second magnetic attraction mechanism, and the fixing groove at least has a first opening which opens downwardly; the second magnetic attraction mechanism is arranged inside an upper wall of the fixing groove; inner side walls of the fixing groove are provided with connecting buckles which are capable of ejecting out of or retracting into the inner side walls of the fixing groove; the connecting buckles are biased to eject out of the inner side walls of the fixing groove; when the shower component is placed adjacent to the fixing component, the first magnetic attraction mechanism is attracted by the second magnetic attraction mechanism and thus moved away from the back surface of the shower body and then embedded into the fixing groove, and when the first magnetic attraction mechanism is embedded into the fixing groove, the connecting buckles are locked in the limiting ring groove.

The fixing component further comprises connecting springs acting on the connecting buckles, the connecting springs provide a biasing force to bias the connecting buckles to eject out of the inner side walls of the fixing groove.

The fixing seat is provided with connecting holes communicating with the inner side walls of the fixing groove, and protruding pieces provided oppositely with respect to the connecting holes; each of the connecting buckles comprises a locking part which passes through a corresponding connecting hole and ejects out of a corresponding inner side wall of the fixing groove, and a limiting part which is limited from passing through the corresponding connecting hole from a side of the connecting hole facing away from the fixing groove; two ends of each of the connecting springs abut against a corresponding protruding piece and a corresponding connecting buckle respectively.

Each of the connecting buckles is provided with studs on which one ends of the corresponding connecting springs are sleeved.

The studs are arranged at two ends of a surface of each of the connecting buckles facing towards the corresponding connecting springs; each of the connecting buckles is provided with two said connecting springs arranged at two ends of the connecting buckle respectively; two of said protruding pieces are also arranged on the fixing seat corresponding to the two said connecting springs for each of the connecting buckles.

The connecting holes are formed on the inner side walls of the fixing groove, and said inner side walls are positioned opposite to each other; there are two said connecting buckles.

A free end of each locking part is provided with an inclined surface; each locking part is movable by the first magnetic attraction mechanism through the inclined surface.

The fixing groove comprises said first opening on a bottom surface of the fixing groove, and a second opening on a side surface of the fixing groove.

The first magnetic attraction mechanism comprises a first shell and a first magnet; the back surface of the shower body is provided with a mounting groove; the first shell is cylindrical and is mounted into the mounting groove, and a circumferential surface of the first shell is provided with said limiting ring groove; the first magnet is arranged inside the first shell.

The first magnetic attraction mechanism further comprises a bottom plate and a reset spring; a circumferential edge of an opening of the mounting groove is provided with a limiting flange; the bottom plate is mounted below the limiting flange; the first shell is detachably connected with the bottom plate, and the first magnet is arranged between the first shell and the bottom plate; the reset spring sleeves on the circumferential surface of the first shell, and two ends of the reset spring abut against the limiting flange and the bottom plate respectively.

A protruding part is arranged on a surface of the bottom plate facing towards the first shell, and the protruding part is embedded into the first shell and is in buckled connection with an inner wall of the first shell.

The first magnetic attraction mechanism further comprises a first gasket arranged between the first magnet and the protruding part.

Preferably, at least two sliders are arranged on a circumferential surface of the bottom plate, inner side walls of the mounting groove are provided with sliding grooves to which the sliders are slidably connected, and the sliding grooves are formed along an axial direction of the mounting groove.

The second magnetic attraction mechanism comprises a second shell and a second magnet; the fixing seat is provided with a mounting hole, and the mounting hole communicates with the upper wall of the fixing groove; the second shell is embedded into the mounting hole; the second magnet is put inside the second shell.

The fixing component further comprises a connector which is fixedly connected to the fixing seat; a rib is arranged in the connector, and the rib is positioned above an upper surface of the second shell.

The second magnetic attraction mechanism further comprises a second gasket arranged in the second shell corresponding to the upper surface of the second shell, the rib abuts against an upper surface of the second gasket, and the second magnet is arranged between the second gasket and the second shell.

A water pathway is arranged in the connector, and a water inlet interface and a water outlet interface are arranged on surfaces of the connector respectively; two ends of the water pathway communicate with the water inlet interface and the water outlet interface respectively.

The fixing component further comprises a ball joint device connected to the water inlet interface.

A filter is arranged in the ball joint device.

According to the technical features detailed above, the present invention achieves the following technical effects:

(1) The connecting buckles which may eject out of or retract into the inner side walls of the fixing groove of the fixing seat are provided. When the first magnetic attraction mechanism on the back surface of the shower body is magnetically attracted by the second magnetic attraction mechanism and is embedded into the fixing groove, the connecting buckles are pressed and retracted, such that the first magnetic attraction mechanism can pass by the connecting buckles and is magnetically attached to the second magnetic attraction mechanism, such that the shower head can be fixed. To fix the shower head, the user is only required to place the shower component near to the fixing component and align the first magnetic attraction mechanism with the second magnetic attraction mechanism. In this way, the operation is simple and convenient.

(2) After the first magnetic attraction mechanism passes by the connecting buckles, the connecting buckles buckle into the limiting ring groove on the circumferential surface of the first magnetic attraction mechanism due to biasing force acted on the connecting buckles, and play a role in axially limiting the first magnetic attraction mechanism, namely that, the first magnetic attraction mechanism is maintained to be magnetically attached to the second magnetic attraction mechanism. The first magnetic attraction mechanism will not be retracted back to the back surface of the shower body after the connecting buckles are buckled into the limiting ring groove, and will also not be loosened from the second magnetic attraction mechanism, thereby improving stability of the shower head after magnetic fixation, and the shower head will not easily fall off due to unintended touch of the user, so that the shower head is safely maintained in its magnetically fixed position.

(3) Since the first magnetic attraction mechanism is retractable towards the back surface of the shower body such that the first magnetic attraction mechanism flushes with the back surface of the shower body when the first magnetic attraction mechanism is not magnetically attracted by the second magnetic attraction mechanism, the back surface of the shower body has a smooth appearance without any protrusions when the user uses the shower component, therefore, the shower head will not be bumped or crashed during use.

### BRIEF DESCRIPTION OF THE DRAWINGS

FIG. 1 is a perspective view of a specific embodiment of the present invention;

FIG. 2 is a schematic diagram of a disassembled state of a specific embodiment of the present invention;

FIG. 3 is an exploded view of a shower component of a specific embodiment of the present invention;

FIG. 4 is an exploded view of a fixing component of a specific embodiment of the present invention; and

FIG. 5 is a cross-sectional view of part of the structure of a specific embodiment of the present invention.

### REFERENCE NUMERALS IN THE FIGURES

10—shower component; 11—shower body; 111—mounting groove;
112—limiting flange; 113—sliding groove; 12—first shell;
121—limiting ring groove; 13—first magnet; 14—bottom plate;
141—protruding part; 142—slider; 15—reset spring;
16—first gasket; 20—fixing component; 21—fixing seat;
211—fixing groove; 211a—first opening; 211b—second opening;
212—mounting hole; 213—connecting hole; 214—protruding piece;
22—connecting buckle; 221—locking part; 222—limiting part;
223—stud; 224—inclined surface; 23—second shell;
24—second magnet; 25—screw; 26—connector;
261—rib; 262—water inlet interface; 263—water outlet interface;
27—second gasket; 28—ball joint device; 29—filter;
210—connecting spring; a—first magnetic attraction mechanism; b—second magnetic attraction mechanism.

### DETAILED DESCRIPTION OF THE INVENTION

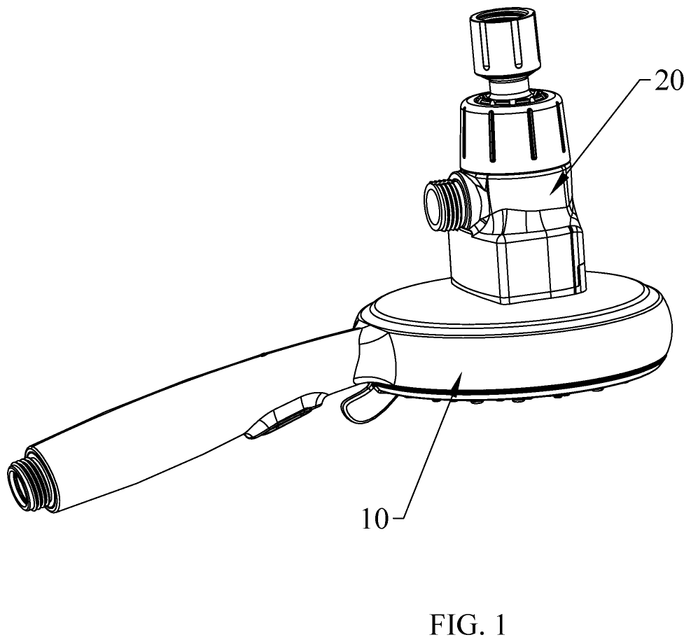

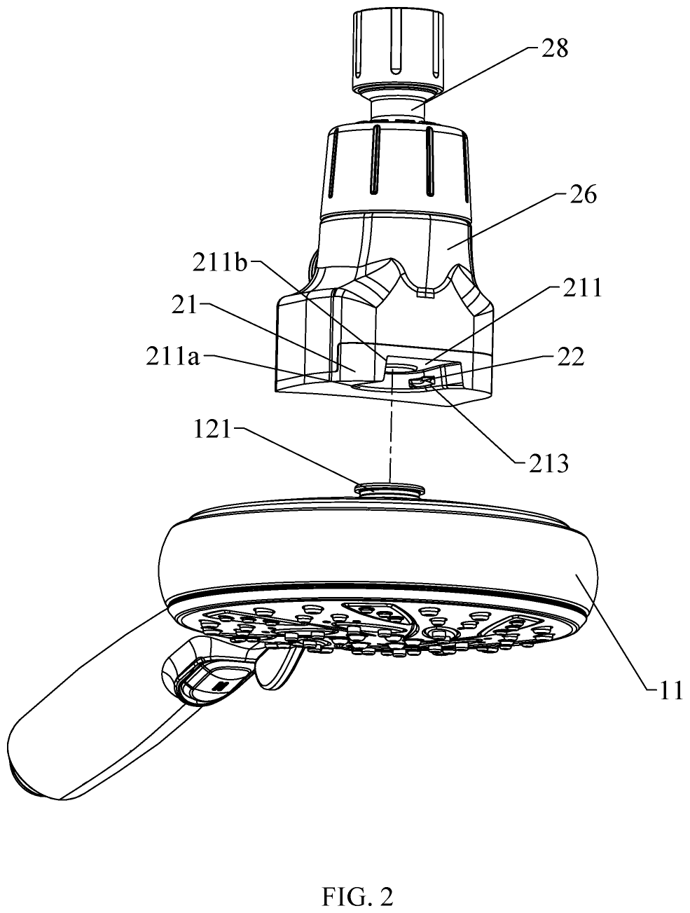

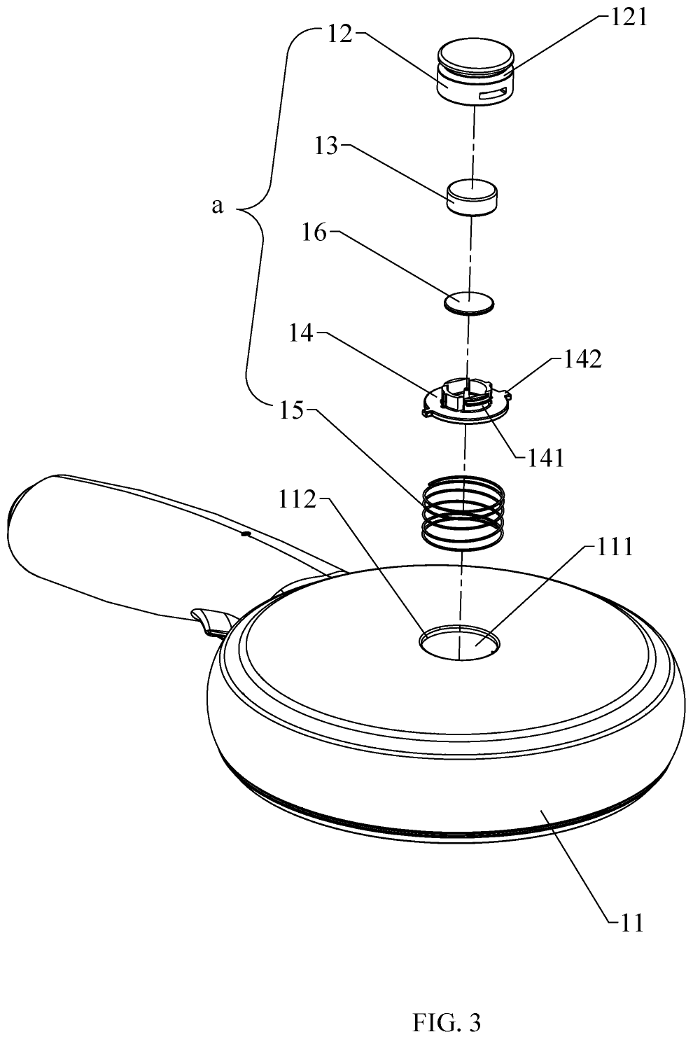

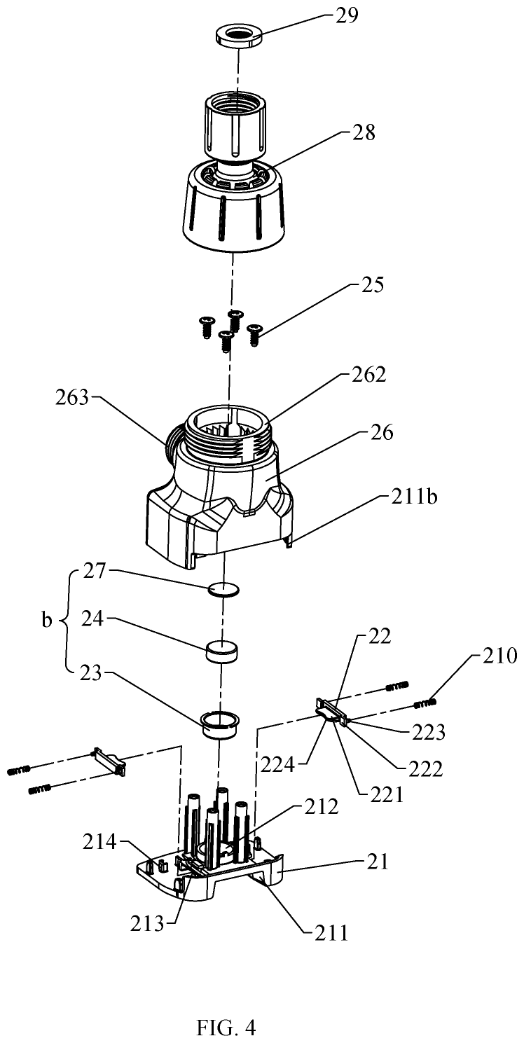

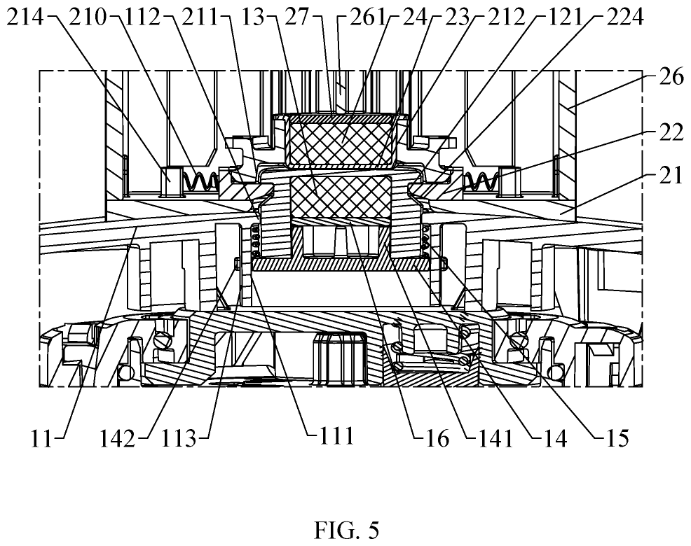

Referring to FIG. 1 to FIG. 5, the present invention discloses a magnetic attraction fixing structure for a shower head, comprising a shower component 10 and a fixing component 20, wherein
the shower component 10 includes a shower body 11 and a first magnetic attraction mechanism a; the first magnetic attraction mechanism a is provided on a back surface of the shower body 11 and is perpendicularly movable away from the back surface of the shower body 11; a circumferential surface of the first magnetic attraction mechanism a is provided with a limiting ring groove 121; an end surface of the first magnetic attraction mechanism a flushes with the back surface of the shower body 11 when the first magnetic attraction mechanism a is not being moved;
the fixing component 20 comprises a fixing seat 21 and a second magnetic attraction mechanism b; the fixing seat 21 is provided with a fixing groove 211 for the first magnetic attraction mechanism a to be embedded in, and the fixing groove 211 at least has a first opening 211a which opens downwardly; the second magnetic attraction mechanism b is arranged inside an upper wall of the fixing groove 211; inner side walls of the fixing groove 211 are provided with connecting buckles 22 which are capable of ejecting out of or retracting into the inner side walls of the fixing groove 211; the connecting buckles 22 are biased to eject out of the inner side walls of the fixing groove 211;
when the shower component 10 is placed adjacent to the fixing component 20, the first magnetic attraction mechanism a is attracted by the second magnetic attraction mechanism b and thus moved away from the back surface of the shower body and then embedded into the fixing groove 211, and when the first magnetic attraction mechanism a is embedded into the fixing groove 211, the connecting buckles 22 are locked in the limiting ring groove 121.

Specific embodiments of the present invention are shown below.

The above fixing groove 211 comprises said first opening 211a on a bottom surface of the fixing groove 211 and a second opening 211b on a side surface of the fixing groove 211, and when the shower head needs to be detached, the shower head can be pulled out from the second opening 211b on the side surface without the need of pushing the connecting buckles 22 back into the inner side walls of the fixing groove 211.

The above first magnetic attraction mechanism a comprises a first shell 12 and a first magnet 13; the back surface of the shower body 11 is provided with a mounting groove 111; the mounting groove 111 is an independent groove which does not communicate with a water pathway inside the shower body 11; the first shell 12 is cylindrical and is mounted into the mounting groove 111, and a circumferential surface of the first shell 12 is provided with said limiting ring groove 121; the first magnet 13 is arranged inside the first shell 12. The cylindrical shape of the first shell 12 enables the shower head to be fixed with the fixing seat 21 according to any arbitrary radial direction of the first shell 12, as long as the first magnetic attraction mechanism a is aligned with the second magnetic attraction mechanism b, and then the first magnetic attraction mechanism a can be attracted by the second magnetic attraction mechanism b through magnetic attraction between the first magnetic attraction mechanism a and the second magnetic attraction mechanism b, such that the first magnetic attraction mechanism a is embedded into the fixing groove 211. since the shower head can be fixed with the fixing seat 21 according to any arbitrary radial direction of the first shell 12, the user can use the present invention more conveniently.

Further, the above first magnetic attraction mechanism a further comprises a bottom plate 14 and a reset spring 15; a circumferential edge of an opening of the mounting groove 111 is provided with a limiting flange 112; the bottom plate 14 is mounted below the limiting flange 112; the first shell 12 is detachably connected with the bottom plate 14, and the first magnet 13 is arranged between the first shell 12 and the bottom plate 14; the reset spring 15 sleeves on the circumferential surface of the first shell 12, and two ends of the reset spring 15 abut against the limiting flange 112 and the bottom plate 14 respectively, so that the bottom plate 14, the first shell 12, and the first magnet 13 are biased to be retracted into the mounting groove 111 through an elastic force of the reset spring 15, such that the end surface of the first shell 12 is kept to be flushed with the back surface of the shower body 11; the back surface of the shower body 11 is a smooth surface when the first magnetic attraction mechanism a is not moved into the fixing groove 211 due to magnetic attraction by the second magnetic attraction mechanism b, and thus the first magnetic attraction mechanism a will not protrude out of the back surface of the shower body 11, thereby avoiding bumping against the first magnetic attraction mechanism a during use of the shower head by the user.

Besides, a protruding part 141 is arranged on a surface of the above bottom plate 14 facing towards the first shell 12, and the protruding part 141 is embedded into the first shell 12 and is in buckled connection with an inner wall of the first shell 12, so as to realize detachable connection between the bottom plate 14 and the first shell 12.

Furthermore, the first magnetic attraction mechanism a further comprises a first gasket 16 arranged between the first magnet 13 and the protruding part 141. The first gasket 16 is made of elastic materials, and can make the protruding part 141 to abut the first magnet 13 tightly, ensuring that the first magnet 13 can tightly abut to the first shell 12.

Finally, at least two sliders 142 are arranged on a circumferential surface of the bottom plate 14, inner side walls of the mounting groove 111 are provided with sliding grooves 113 to which the sliders 142 are slidably connected, and the sliding grooves 113 are formed along an axial direction of the mounting groove 111. Through slidable connection of the sliders 142 with the sliding grooves 113, the bottom plate 14 can be guided during movement, that is, movement of the first magnetic attraction mechanism a in the mounting groove 111 is guided, such that structural stability is improved.

The second magnetic attraction mechanism b comprises a second shell 23 and a second magnet 24; the fixing seat 21 is provided with a mounting hole 212, and the mounting hole 212 communicates with the upper wall of the fixing groove 211; the second shell 23 is embedded into the mounting hole 212; the second magnet 24 is put inside the second shell 23.

In some embodiments of the above fixing component 20, the fixing component 20 further comprises a connector 26 which is fixedly connected to the fixing seat 21 through a plurality of screws 25; a rib 261 is arranged in the connector 26, and the rib 261 is positioned above an upper surface of the second shell 23, such that the second shell 23 is fixedly fitted in the mounting hole 212.

Further, the second magnetic attraction mechanism b further comprises a second gasket 27 arranged in the second shell 23 corresponding to the upper surface of the second shell 23, the rib 261 abuts against an upper surface of the second gasket 27, and the second magnet 24 is arranged between the second gasket 27 and the second shell 23. The second gasket 27 is made of elastic materials, and can make the rib 261 push the second magnet 24 tightly, ensuring that the second magnet 24 can be tightly attached to the second shell 23.

Also, a water pathway is arranged in the connector 26, and a water inlet interface 262 and a water outlet interface 263 are arranged on surfaces of the connector 26 respectively; two ends of the water pathway communicate with the water inlet interface 262 and the water outlet interface 263 respectively. In other words, the fixing component 20 is not only a fixing device for mounting the shower head, but also contains the water pathway, thereby enriching the functions of the fixing device. Accordingly, the connector 26 which is fixed on the wall and contains water outlet function may also be connected with the shower head by a soft hose which connects a water inlet end of the shower head to the water outlet interface 263 of the connector 26. As such, the connector 26 is integrated with two different purposes, so that the installation design of bathroom products on the wall is simplified.

Furthermore, the fixing component 20 further comprises a ball joint device 28 connected to the water inlet interface 262. Through a rotating connection function of the ball joint device 28, an angle of the connector 26 can be adjusted according to the actual use requirement of a user. In other words, an angle of the fixing seat 21 can also be adjusted.

Moreover, a filter 29 is arranged in the ball joint device 28, so that impurities in water can be filtered, and cleanliness of water output from the shower head is improved.

The fixing component 20 further comprises connecting springs 210 acting on the connecting buckles 22, the connecting springs 210 provides a biasing force to bias the connecting buckles 22 to eject out of the inner side walls of the fixing groove 211; when the connecting buckles 22 are pressed by the first magnetic attraction mechanism a and retracted into the inner side walls of the fixing groove 211, the connecting springs 210 are compressed, such that the connecting springs 210 store energy, and the connecting buckles 22 are pushed into the limiting ring groove 121 of the first magnetic attraction mechanism a after the first magnetic attraction mechanism a is attracted to the second magnetic attraction mechanism b and fixed into the fixing groove 211.

Further, the fixing seat 21 is provided with connecting holes 213 communicating with the inner side walls of the fixing groove 211, and protruding pieces 214 provided oppositely with respect to the connecting holes 213; each connecting buckle 22 comprises a locking part 221 which passes through a corresponding connecting hole 213 and ejects out of a corresponding inner side wall of the fixing groove 211, and a limiting part 222 which is limited from passing through a corresponding connecting hole 213 from a side of the connecting hole facing away from the fixing groove 211; two ends of each connecting spring 210 abut against a corresponding protruding piece 214 and a corresponding connecting buckle 22 respectively; the biasing force of the connecting springs 210 enables the connecting buckles 22 to bias the locking parts 221 to pass through the connecting holes 213 and eject out of the inner side walls of the fixing groove 211; the connecting holes 213 play a role in guiding movements of the connecting buckles 22.

Besides, each of the connecting buckles 22 is provided with studs 223 on which one ends of the corresponding connecting springs 210 are sleeved, so as to maintain relative positions between the connecting springs 210 and the corresponding connecting buckle 22.

Moreover, the studs 223 are arranged at two ends of a surface of each connecting buckle 22 facing towards the corresponding connecting springs 210. In other words, each connecting buckle 22 is provided with two said connecting springs 210 arranged at two ends of the connecting buckle 22 respectively, and two corresponding protruding pieces 214 are also arranged on the fixing seat 21 corresponding to the two connecting springs 210 for each connecting buckle 22. The two connecting springs 210 acting on each connecting buckle 22 ensure each connecting buckle 22 to receive balance and stable force.

Finally, the connecting holes 213 are formed on the inner side walls of the fixing groove 211, and said inner side walls are opposite to each other, that is to say, there are two said connecting holes 213 one of which arranged on one of said inner side walls of the fixing groove 211, and another one of which arranged on another one of said inner side walls of the fixing groove 211; and correspondingly, there are two said connecting buckles 22, arranged opposite to each other. Two opposite connecting buckles 22 buckle into two sides of the limiting ring groove 121 respectively, such that the fixing effect is more stable.

In addition, a free end of each of the locking parts 221 is provided with an inclined surface 224; when the first magnetic attraction mechanism a is being attracted into the fixing groove 211, a periphery of the first magnetic attraction mechanism a abuts against each inclined surface 224, so as to push the corresponding locking part 221 to push the corresponding connecting buckle 22 into the corresponding inner side wall of the fixing groove 211, so as to allow the first magnetic attraction mechanism a to continue to move and is thus completely embedded into the fixing groove 211 in which the first magnetic attraction mechanism a is magnetically attracted to the second magnetic attraction mechanism b.

According to the above technical features, the present invention provides connecting buckles 22 which may eject out of or retract into the inner side walls of the fixing groove 211 of the fixing seat 21; when the first magnetic attraction mechanism a on the back surface of the shower body 11 is magnetically attracted by the second magnetic attraction mechanism b and is embedded into the fixing groove 211, the connecting buckles 22 are pressed and retracted, such that the first magnetic attraction mechanism a can pass by the connecting buckles 22 and is magnetically attached to the second magnetic attraction mechanism b, such that the shower head can be fixed. To fix the shower head, the user is only required to place the shower component 10 near to the fixing component 20 and align the first magnetic attraction mechanism a with the second magnetic attraction mechanism b. In this way, the operation is simple and convenient. After the first magnetic attraction mechanism a passes by the connecting buckles 22, the connecting buckles 22 buckle into the limiting ring groove 121 on the circumferential surface of the first magnetic attraction mechanism a due to biasing force acted on the connecting buckles 22, and play a role in axially limiting the first magnetic attraction mechanism a, namely that, the first magnetic attraction mechanism a is maintained to be magnetically attached to the second magnetic attraction mechanism b. The first magnetic attraction mechanism a will not be retracted back to the back surface of the shower body 11 after the connecting buckles 22 buckled into the limiting ring groove 121, and will also not be loosened from the second magnetic attraction mechanism b, thereby improving stability of the shower head after magnetic fixation, and the shower head will not easily fall off due to unintended touch of the user, so that the shower head is safely maintained in its magnetically fixed position. Since the first magnetic attraction mechanism a is retractable towards the back surface of the shower body 11 such that the first magnetic attraction mechanism a flushes with the back surface of the shower body 11 when the first magnetic attraction mechanism a is not magnetically attracted by the second magnetic attraction mechanism b, the back surface of the shower body 11 has a smooth appearance without any protrusions when the user uses the shower component 10, therefore, the shower head will not be bumped or crashed during use.

The above embodiments and drawings are not intended to limit the form and style of the products of the present invention, and any suitable changes or modifications made by those skilled in the art should be considered as not departing from the patent scope of the present invention.

What is claimed is:

1. A magnetic attraction fixing structure for a shower head, comprising:
a shower component and a fixing component, wherein,
the shower component comprises a shower body and a first magnetic attraction mechanism; the first magnetic attraction mechanism is provided on a back surface of the shower body and is perpendicularly movable away from the back surface of the shower body; a circumferential surface of the first magnetic attraction mechanism is provided with a limiting ring groove; an end surface of the first magnetic attraction mechanism flushes with the back surface of the shower body when the first magnetic attraction mechanism is not being moved;
the fixing component comprises a fixing seat and a second magnetic attraction mechanism; the fixing seat is provided with a fixing groove in which the first magnetic attraction mechanism is embedded when being magnetically attracted by the second magnetic attraction mechanism, and the fixing groove at least has a first opening which opens downwardly; the second magnetic attraction mechanism is arranged inside an upper wall of the fixing groove; inner side walls of the fixing groove are provided with connecting buckles which are capable of ejecting out of or retracting into the inner side walls of the fixing groove; the connecting buckles are biased to eject out of the inner side walls of the fixing groove;
when the shower component is placed adjacent to the fixing component, the first magnetic attraction mechanism is attracted by the second magnetic attraction mechanism and thus moved away from the back surface of the shower body and then embedded into the fixing groove, and when the first magnetic attraction mechanism is embedded into the fixing groove, the connecting buckles are locked in the limiting ring groove.

2. The magnetic attraction fixing structure of claim 1, wherein the fixing component further comprises connecting springs acting on the connecting buckles, the connecting springs provide a biasing force to bias the connecting buckles to eject out of the inner side walls of the fixing groove.

3. The magnetic attraction fixing structure of claim 2, wherein the fixing seat is provided with connecting holes communicating with the inner side walls of the fixing groove, and protruding pieces provided oppositely with respect to the connecting holes; each of the connecting buckles comprises a locking part which passes through a corresponding connecting hole and ejects out of a corresponding inner side wall of the fixing groove, and a limiting part which is limited from passing through the corresponding connecting hole from a side of the connecting hole facing away from the fixing groove; two ends of each of the connecting springs abut against a corresponding protruding piece and a corresponding connecting buckle respectively.

4. The magnetic attraction fixing structure of claim 3, wherein each of the connecting buckles is provided with studs on which one ends of the corresponding connecting springs are sleeved.

5. The magnetic attraction fixing structure of claim 4, wherein the studs are arranged at two ends of a surface of each of the connecting buckles facing towards the corresponding connecting springs; each of the connecting buckles is provided with two said connecting springs arranged at two ends of the connecting buckle respectively; two said protruding pieces are also arranged on the fixing seat corresponding to the two said connecting springs for each of the connecting buckles.

6. The magnetic attraction fixing structure of claim 3, wherein the connecting holes are formed on the inner side walls of the fixing groove, and said inner side walls are positioned opposite to each other; there are two said connecting buckles.

7. The magnetic attraction fixing structure of claim 3, wherein a free end of each locking part is provided with an inclined surface; each locking part is movable by the first magnetic attraction mechanism through the inclined surface.

8. The magnetic attraction fixing structure of claim 1, wherein the fixing groove comprises said first opening on a bottom surface of the fixing groove, and a second opening on a side surface of the fixing groove.

9. The magnetic attraction fixing structure of claim 1, wherein the first magnetic attraction mechanism comprises a first shell and a first magnet; the back surface of the shower body is provided with a mounting groove; the first shell is cylindrical and is mounted into the mounting groove, and a circumferential surface of the first shell is provided with said limiting ring groove; the first magnet is arranged inside the first shell.

10. The magnetic attraction fixing structure of claim 9, wherein the first magnetic attraction mechanism further comprises a bottom plate and a reset spring; a circumferential edge of an opening of the mounting groove is provided with a limiting flange; the bottom plate is mounted below the limiting flange; the first shell is detachably connected with the bottom plate, and the first magnet is arranged between the first shell and the bottom plate; the reset spring sleeves on the circumferential surface of the first shell, and two ends of the reset spring abut against the limiting flange and the bottom plate respectively.

11. The magnetic attraction fixing structure of claim 10, wherein a protruding part is arranged on a surface of the bottom plate facing towards the first shell, and the protruding part is embedded into the first shell and is in buckled connection with an inner wall of the first shell.

12. The magnetic attraction fixing structure of claim 11, wherein the first magnetic attraction mechanism further comprises a first gasket arranged between the first magnet and the protruding part.

13. The magnetic attraction fixing structure of claim 10, wherein at least two sliders are arranged on a circumferential surface of the bottom plate, inner side walls of the mounting groove are provided with sliding grooves to which the sliders are slidably connected, and the sliding grooves are formed along an axial direction of the mounting groove.

14. The magnetic attraction fixing structure of claim 1, wherein the second magnetic attraction mechanism comprises a second shell and a second magnet; the fixing seat is provided with a mounting hole, and the mounting hole communicates with the upper wall of the fixing groove; the second shell is embedded into the mounting hole; the second magnet is put inside the second shell.

15. The magnetic attraction fixing structure of claim 14, wherein the fixing component further comprises a connector which is fixedly connected to the fixing seat; a rib is arranged in the connector, and the rib is located above an upper surface of the second shell.

16. The magnetic attraction fixing structure of claim 15, wherein the second magnetic attraction mechanism further comprises a second gasket arranged in the second shell corresponding to the upper surface of the second shell, the rib abuts against an upper surface of the second gasket, and the second magnet is arranged between the second gasket and the second shell.

17. The magnetic attraction fixing structure of claim 15, wherein a water pathway is arranged in the connector, and a water inlet interface and a water outlet interface are arranged on surfaces of the connector respectively; two ends of the water pathway communicate with the water inlet interface and the water outlet interface respectively.

18. The magnetic attraction fixing structure of claim 17, wherein the fixing component further comprises a ball joint device connected to the water inlet interface.

19. The magnetic attraction fixing structure of claim 18, wherein a filter is arranged in the ball joint device.
